(19) United States
(12) Patent Application Publication
(10) Pub. No.: US 2021/0194409 A1
(43) Pub. Date: Jun. 24, 2021

(54) ADJUSTMENT FITTING AND CARRIER SYSTEM FOR SOLAR PANELS

(71) Applicant: S-Rack K.K., Yokohama (JP)

(72) Inventors: Dominik Bastian Gruetzner, Isen (DE); Pirmin Schmidbauer, Yokohama (JP)

(73) Assignee: S-Rack K.K., Yokohama (JP)

(21) Appl. No.: 17/249,426

(22) Filed: Mar. 2, 2021

Related U.S. Application Data
(63) Continuation of application No. PCT/IB2019/056093, filed on Jul. 17, 2019.

(30) Foreign Application Priority Data
Sep. 3, 2018 (DE) 10 2018 214 937.2
Dec. 7, 2018 (DE) 10 2018 221 183.3

(51) Int. Cl. H02S 20/10; F24S 25/12; F16B 7/18; F16B 5/12

(52) U.S. Cl. CPC H02S 20/10; F24S 25/12; F24S 2025/019; F16B 5/123; F16B 7/187

(57) ABSTRACT

An adjustment fitting for fastening a solar panel carrier rail to a post profile that is anchored to the ground, includes a foot segment, a head segment and an adjustment element. The foot segment has a first mounting flange and includes a fastening portion, which extends away from the mounting flange on one side of the first mounting flange and is used to fasten the foot segment to the post profile. The head segment includes a second mounting flange for bearing the head segment and fastening it to the first mounting flange of the foot segment, which can be inserted into the carrier rail in portions and includes an elongate hole in two side walls that are arranged opposite one another. The adjustment element, which is arranged between the two side walls of the head segment, can be locked in different latching positions on the head segment.

### CROSS-REFERENCE TO RELATED APPLICATIONS

This continuation application claims priority to PCT/162019/056093 filed on Jul. 17, 2019, which has published as WO 2020/049374 A1, and also German application numbers 10 2018 214 937.2 filed on Sep. 3, 2018 and 10 2018 221 183.3 filed on Dec. 7, 2018, the entire contents of which are fully incorporated herein with these references.

### DESCRIPTION

### Field of the Invention

The present invention generally relates to solar panels. More particularly, the present invention relates to an adjustment fitting for fastening a solar panel carrier rail to a post profile that is anchored to the ground.

### Background of the Invention

When installed on roofs or outdoors, solar panels such as photovoltaic modules or collector modules are usually fastened on parallel profile rails or carrier rails. The carrier rails are each fastened to post profiles by means of fittings, which post profiles are anchored to the ground. Such post profiles can be formed as drive profiles, for example, which are driven directly into the ground. The post profiles and the carrier rails generally have a U-shaped or DIN rail-shaped cross section for cost reasons. The post profiles and carrier rails can thereby be provided as inexpensive rolled profiles.

In practice, when anchoring the post profiles, in particular when driving the post profiles into the ground, it is not generally possible to ensure that the free ends of the post profiles are arranged precisely linearly and that the post profiles are oriented precisely perpendicularly. This is often the case in particular when the terrain is uneven or the ground conditions are difficult. This makes it more difficult to finally fasten the (linear) carrier rails to the post profiles using conventional fitting elements.

### SUMMARY OF THE INVENTION

The object of the invention is therefore to provide an adjustment fitting, which allows for simpler fastening of the profile rails or carrier rails to the post profiles, even when the free ends of the post profiles, which are provided for receiving a solar panel support, are not arranged precisely linearly.

This object is achieved by an adjustment fitting having the feature specified in an independent claim. The carrier system according to the invention is also specified in another independent claim. Preferred embodiments of the invention form the subject matter of the dependent claims and the description.

The adjustment fitting according to the invention is used to fasten a profile rail or carrier rail to a post profile that is anchored to the ground. The carrier rail preferably has a U-shaped cross section. In the present case, a post profile is understood to mean a (U-) profile rod or a profile tube, which is to be anchored to the ground and can in particular be made of metal. The adjustment fitting comprises a foot segment having a first mounting flange and having a fastening portion, which extends away from the mounting flange on one side of the mounting flange and is used to fasten the foot element to the post profile. The adjustment fitting comprises a head segment having a second mounting flange for bearing the head segment and fastening it to the first mounting flange of the foot segment. The head segment is intended to be inserted into the carrier rail portion by portion, and is provided with through-recesses in the form of elongate holes in two side walls that are arranged opposite one another. The two elongate holes each extend in a direction that is axial to the longitudinal axis of the head segment on the particular side wall of the head segment.

An adjustment element is arranged between the two side walls of the head segment. The adjustment element is provided with first latching means on its two end faces that face away from one another, which latching means interacts with second latching means on the insides of the two side walls of the head segment such that the adjustment element can move in the direction of the longitudinal axis of the head segment, relative to the head segment, into different latching positions when the adjustment fitting is not mounted, and the adjustment element being provided with a through-recess, which is aligned with the elongate holes in the head segment, for a fastening means that is used to fasten the head segment to the carrier rail and to lock, i.e. fix, the adjustment element in its particular latching position on the head segment, such that it cannot move relative to the head segment, by means of the compression of the side walls of the head segment, i.e. by means of the approximation of the two side walls, at least in portions. The adjustment element is used to receive a fastening means, which extends through the carrier rail, the elongate hole through-recesses in the head segment and the adjustment element when the adjustment fitting is mounted. This fastening means can be formed as a screw or a bolt in particular.

The adjustment fitting allows for a quasi-stepless and simple height adjustment when the carrier rail is mounted to post profiles that are anchored to the ground, the free ends of which do not lie behind one another in a precisely linear fashion. Likewise, the latching means of the adjustment element and of the head segment that interlock allow the carrier rail to be fastened to the adjustment fitting in a manner that is particularly stable under load. The adjustment element also allows for the longitudinal extension of the fastening means to be supported against the carrier rail between the respective load-bearing points so that overloading of the fastening means, for example in the event of wind loads that frequently act on the solar panels, can be reliably counteracted. By means of the substantially two-part structure of the adjustment fitting having a foot and a head segment, additional mounting tolerances can be compensated for. The adjustment fitting has a very simple design and can be cheaply produced, particularly when mass produced.

According to a preferred development of the invention, the first latching means and/or the second latching means each comprise corrugations. Corrugations are understood to mean rib-like profile projections. The corrugations on the adjustment element and preferably also on the two side walls of the head segment preferably each extend over the entire width or end face of the adjustment element. As a result, a force is introduced over a large proportion of the surface area of the contact surface region of the two components. The corrugations can each have a uniform corrugation length l and corrugation height h. Therefore, the corrugations can each have a corrugation length of 1 mm and a corrugation height of 1 mm, for example. More particularly preferably, the corrugations on the adjustment element and the corrugations on the insides of the two side walls of the head segment are evenly spaced apart in the direction of the longitudinal axis of the head segment. For example, directly adjacent corrugations can be spaced apart by 1.5 mm. Said spacing is preferably greater than the corrugation height at least by the factor 1.3.

According to a development of the invention, the first mounting flange and the second mounting flange each comprise fastening recesses, which are in alignment, at least in portions, in the direction of the longitudinal axis of the head segment and through each of which a fastening means, in particular in the form of a screw, extends. By means of the fastening means, the head segment and the foot segment can be releasably fastened to one another.

If the fastening recesses in the first mounting flange and/or the fastening recesses in the second mounting flange are each formed as an elongate hole, the head segment and the foot segment can be monoaxially or biaxially arranged in different relative positions. This provides additional adjustment possibilities, which simplify mounting of the carrier rail to the post profile.

According to the invention, the fastening portion of the foot segment preferably extends away from the mounting flange on one side of the second mounting flange. In its free end portion, the fastening portion particularly preferably comprises one, preferably only one, through-opening for a fastening means. This allows for hinged fastening of the foot portion to the post profile. As a result, the entire adjustment fitting can be fastened to the post profile in different swivel positions relative to the post profile and therefore malpositions of the free end of a post profile are compensated for. If the through-opening extends over the entire width of the first mounting plate, a load can be introduced into the foot segment, particularly over a large proportion of its surface area. Overstressing of the fastening portion can thereby be counteracted.

With regard to particularly inexpensive mass production of the adjustment fitting, the fastening portion can comprise two legs, which engage on the mounting flange and join together, forming the free end portion. In this case, the foot portion can in particular be formed as one piece. The foot portion is preferably formed as a cast element or as a CNC milled part, preferably made of metal.

According to the invention, a particularly high load-bearing capacity can be achieved for the head segment of the adjustment fitting by the two side walls of the head segment being connected to one another by means of a back portion (=end wall) that is spaced apart from the second mounting flange. This embodiment also offers manufacturing advantages. The head portion can therefore be formed by a portion of a continuous casting profile or an extruded profile, for example.

From a cost point of view and with regard to the fatigue limit of the adjustment fitting, according to the invention the head segment can be formed as one piece.

The adjustment fitting as a whole is preferably made of metal, in particular steel or aluminum. More particularly preferably, neither the head piece nor the foot segment comprises a welded joint. This allows for highly cost-effective manufacture of the adjustment fitting.

The adjustment element can comprise a main part and a closure element, each of which delimit part of the circumference of the bore. In other words, a portion of the circumference of the bore is delimited by the main part and an additional portion, in particular the remaining portion of its circumference, is delimited by the closure element. In principle, the main part and the closure element are separate components. The adjustment element therefore consists of several parts, in particular two parts. The main part and the closure element are advantageously designed such that, for fastening means arranged on the head segment, the main part and the closure element can be inserted between the side walls of the head segment. Accordingly, the main part and the closure element can advantageously also be separated from one another and from the head segment, without removing the fastening means. This can simplify mounting and adjustment of the adjustment fitting. In particular, the functional height of the adjustment fitting can be modified without the fastening means and if necessary the carrier rail being detached from the head segment.

The main part of the adjustment element can comprise a slot in each of its two end faces, which slot is open on one side. In this case, a closed end of the particular slot can delimit part of the circumference of each of the bores. The slots that are open on one side make it possible to place the main part over the fastening means such that the fastening means is arranged in the region of the closed ends.

The closure element can particularly preferably be inserted into the main part. The closure element can in particular be inserted into the slots in the side walls. By inserting the closure element into the main part, the adjustment element can be assembled, the fastening means being arrangeable in the bore. The closure element can advantageously be latched inside the main part. This can prevent the closure element from accidentally releasing from the main part, for example before the adjustment element is locked to the head segment by means of the fastening means. At the same time, the latching engagement can be simply released for removal or height-adjustment purposes. The slots in the end faces can comprise indentations and the closure element can comprise corresponding bulges. By means of the interaction between the bulges and the indentations, the closure element can be interlockingly held, i.e. latched, on the main part. Alternatively or in addition, the closure element can be clamped, i.e. frictionally held, on the main part.

The carrier system according to the invention for one or more solar panels comprises:

at least two post profiles, which are to be anchored or are anchored to the ground at a spacing from one another;
at least one carrier rail, which is fastened to each of the post profiles by means of an adjustment fitting as mentioned above, in each case, the fastening portion of the foot segment of any adjustment fitting extending into a post profile at the end face and being secured to the post profile by means of a fastening means that engages through the through-opening.

The head segment extends into the carrier rail, in portions, transversely to the longitudinal extension of the carrier rail and, by means of a fastening means that engages through the mounting profile, the two side walls of the head segment and the adjustment element, is fixed to the mounting profile, by clamping or compressing the adjustment element between the two side walls of the head segment, such that it cannot axially move on the head segment.

Further advantages of the invention can be found in the description and the drawings. The embodiment shown and described should not be understood as an exhaustive list, but is instead an example for depicting the invention.

### BRIEF DESCRIPTION OF THE DRAWINGS

In the drawings:

FIG. 1 is a side view of a carrier system for solar panels;

FIG. 2 is a detailed cut-out of the carrier system according to FIG. 1;

FIG. 3 is an exploded view of the parts of the carrier system according to FIG. 2 that shows an adjustment fitting;

FIG. 4 is a perspective view of the adjustment fitting in the non-mounted state;

FIG. 5 shows the adjustment fitting according to FIG. 4 in a partially mounted state;

FIG. 6 is a view of an adjustment element of the adjustment fitting that shows its corrugated end face;

FIG. 7 is a cut-out of the longitudinal section of the adjustment element according to FIG. 6;

FIG. 8 is a perspective view of an alternative embodiment of an adjustment fitting;

FIG. 9 is a front view of the adjustment fitting according to FIG. 8;

FIG. 10 is a perspective view of another alternative embodiment of an adjustment fitting;

FIG. 11 is a front view of the adjustment fitting according to FIG. 10;

FIG. 12 is a perspective view of an adjustment fitting in a fourth embodiment, mounted on a post profile;

FIG. 13 is an exploded view of the adjustment fitting according to FIG. 12;

FIG. 14a is a perspective view of a main part of an adjustment element of the adjustment fitting according to FIGS. 12 and 13;

FIG. 14b is a side view of the main part in FIG. 14a;

FIG. 15a is a perspective view of a closure element of the adjustment element of the adjustment fitting according to FIGS. 12 and 13; and

FIG. 15b is a side view of the closure element in FIG. 15a.

### DETAILED DESCRIPTION OF THE PREFERRED EMBODIMENTS

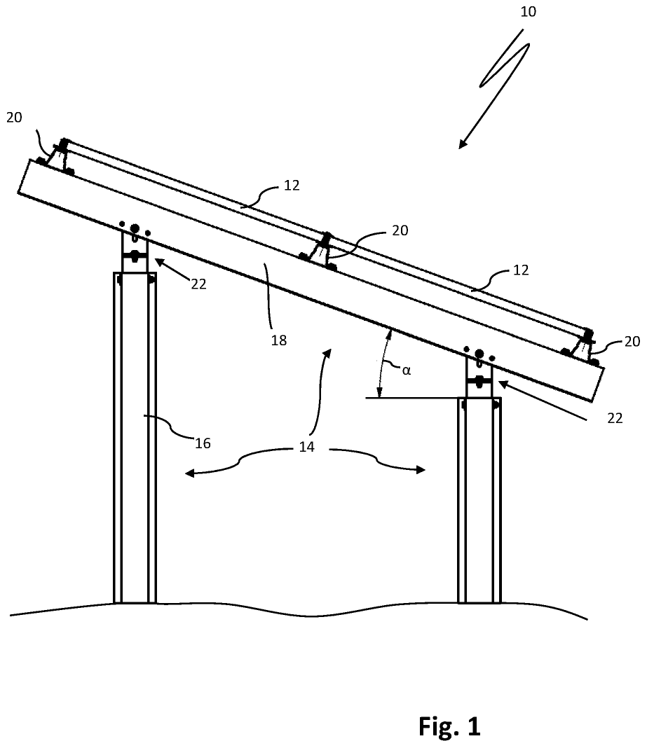

FIG. 1 shows a solar panel arrangement 10 comprising a plurality of solar panels 12, which are arranged on a carrier system 14. The solar panels 12 can be in the form of photovoltaic modules or sun collectors. The carrier system 14 comprises a plurality of post profiles 16, which are anchored to the ground. The post profiles 16 can be driven into the ground, embedded in concrete therein or anchored to the ground in some other way. In each case, at least two post profiles 16 are used to support a carrier rail 18, on which the solar panels 12 are held, in this case by means of additional transverse profiles 20 that each rest against at least two carrier rails 18.

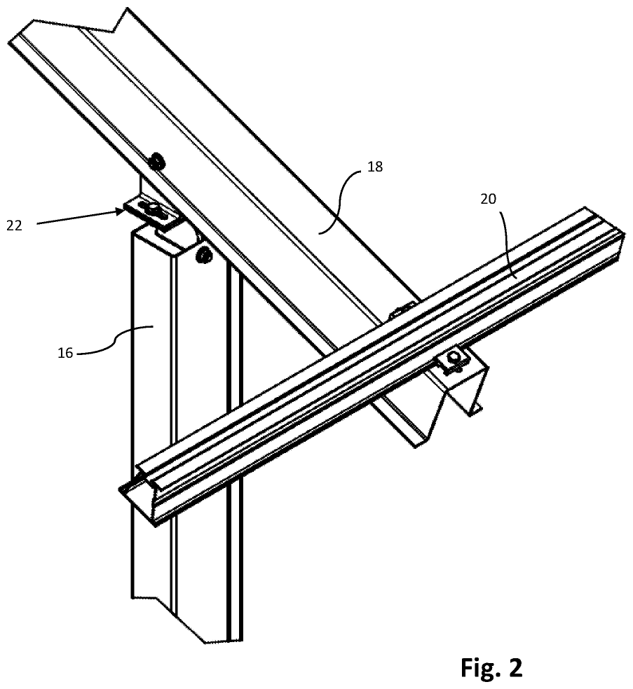

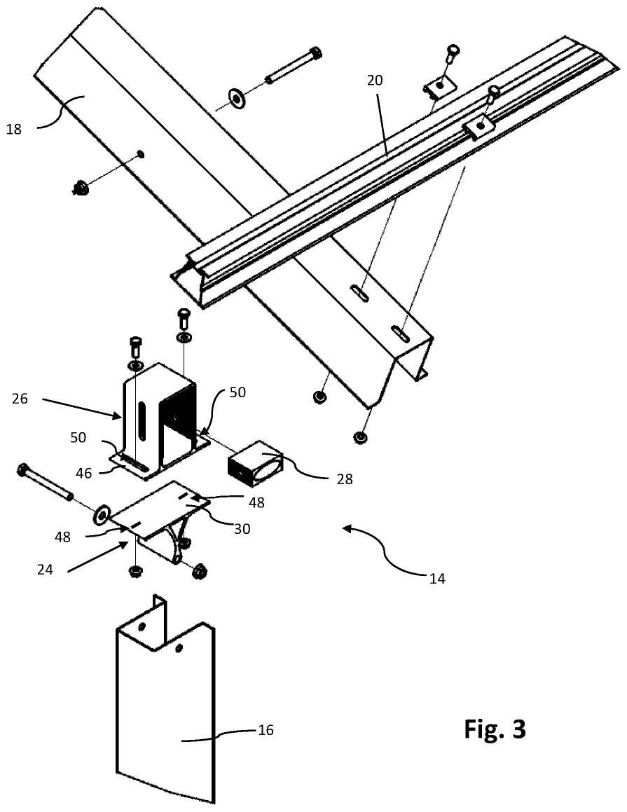

According to FIGS. 2 and 3, the post profiles 16 and the carrier rails 18 each have a U-shaped cross section or a substantially U-shaped cross section. The post profiles 16 and the carrier rails 18 can in particular be formed as top hat profiles. The carrier rails 18 are arranged inclined with respect to the horizontal H and can be arranged at a work angle α of, for example, 20° with respect to the horizontal H (FIG. 1). Of course, in practice the angle α is selected such that the solar panel 12 is oriented with respect to the sun in the given manner in each case.

In order to fasten the carrier rails 18 to the respective post profiles 16, an adjustment fitting 22 is used in each case. According to FIGS. 3 to 5, the adjustment fitting 22 is made up of several parts. According to the exploded view shown in FIG. 3 of the carrier system 14, the adjustment fitting 22 comprises a foot segment 24, which is to be fastened to the post profile 16, a head segment 26, which is to be fastened to the carrier rail 18, and an adjustment element 28.

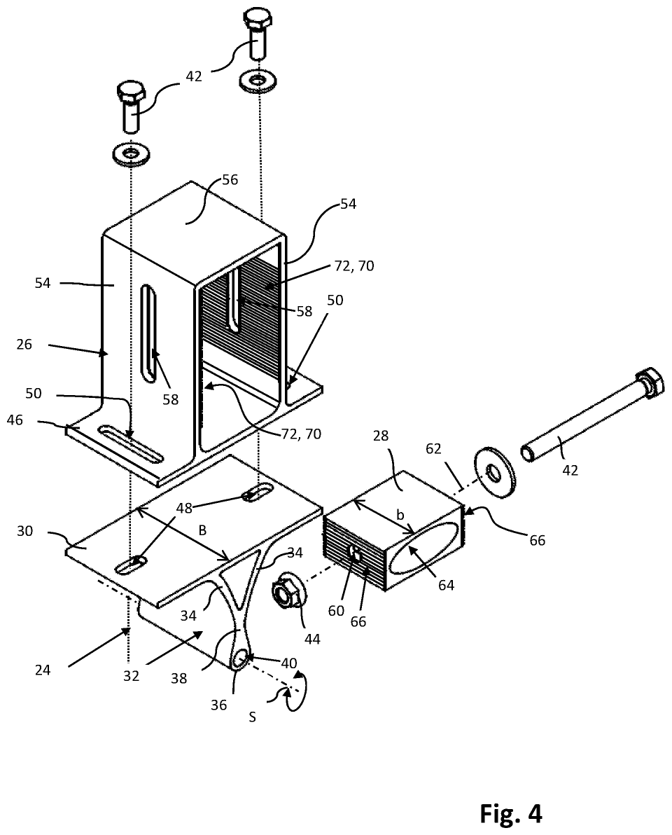

The foot segment 24 comprises a first mounting flange 30 and a fastening portion 32, which extends away from the mounting flange 30 on one side of the mounting flange 30. The fastening portion 32 can comprise two legs 34, which are spaced apart from one another, are arranged on the first mounting flange 30, converge in the direction of the free end 36 of the fastening portion 32 and merge to form a free end region 38 of the fastening portion 32. In its free end region 38, the fastening portion 32 is provided with a single through-opening 40 for a fastening means 42, in this case a screw. A nut 44 is used to secure the screw. The through-opening 40 (FIG. 4) advantageously extends over the entire width B of the first mounting flange 30 of the foot segment 24. By means of the single through-opening 40, the foot segment 24 can be hingedly fastened to the post profile 16, i.e. such that it can swivel about the swivel axis S (cf. FIG. 1). The foot segment 24 of the adjustment fitting 22 is formed as one piece and can in particular be made of metal, preferably steel or aluminum.

The head segment 26 comprises a second mounting flange 46 for bearing the head segment 26 and fastening it to the first mounting flange 30 of the foot segment 24. The two mounting flanges 30, 46 are each designed having fastening recesses 48, 50 for receiving a fastening means 42 in each case, in this case a screw. The fastening recesses 48, 50 in the mounting flanges 30, 46 of the foot segment 24 and/or the head segment 26 are each preferably formed as elongate holes so as to be able to fasten the head segment 26 and the foot segment 24 to one another in different movement positions relative to one another. As a result, positional tolerances of the particular post profile 16 (FIG. 1) relative to the carrier rail 18 can be compensated for.

The head segment 26 can be introduced into the respectively assigned carrier rail 18 in portions in the direction of its longitudinal axis 52 (FIG. 3) and transversely to the longitudinal extension of said rail.

In this case, the head segment 26 comprises two side walls 54 that are arranged opposite one another. The side walls 54 extend away from the second mounting flange 46 and are arranged on the second mounting flange 46 so as to extend in parallel with one another. In this case, the side walls 54 are connected to one another by means of an end wall 56 of the head segment 26 that is spaced apart from the second mounting flange 46. The two side walls 54 of the head portion 26 are each provided with an elongate hole 58. The head segment 26 is formed as one piece and can be made in particular of metal, preferably steel or aluminum.

The adjustment element 28 is arranged between the two side walls 54 of the head segment 26. The adjustment element 28 is provided with a bore 60. The bore 60 receives a fastening means 42, in this case a screw, which is used to fasten the head segment 26 to the particular carrier rail 18. The bore 60 extends through the adjustment element 28 along the body axis of the adjustment element 28, which axis is denoted by 62. It should be noted that the elongate holes 58 in the two side walls 54 of the head segment 26 are aligned with the bore 60 in the direction of the body axis 62 of the adjustment element 28. In order to use as little material as possible, the adjustment element according to FIG. 4 can also be provided with a through-recess 64, which extends through the adjustment element 28, transversely to the body axis 62 of the adjustment element 28.

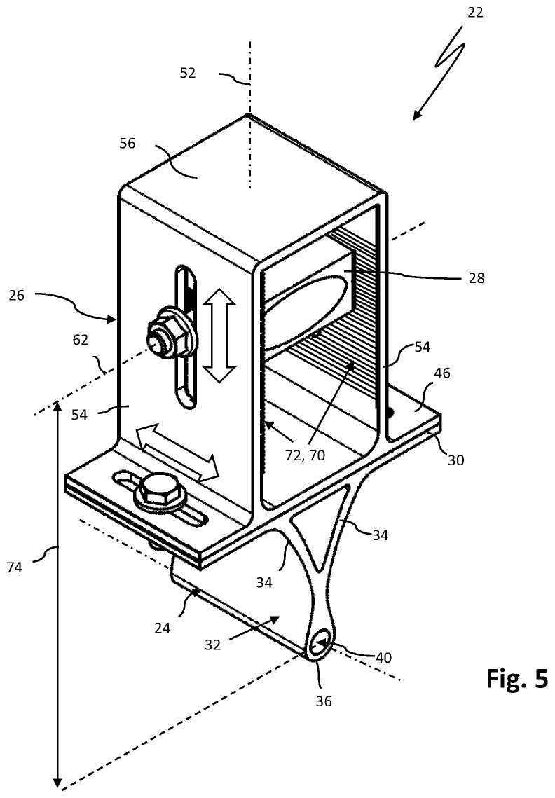

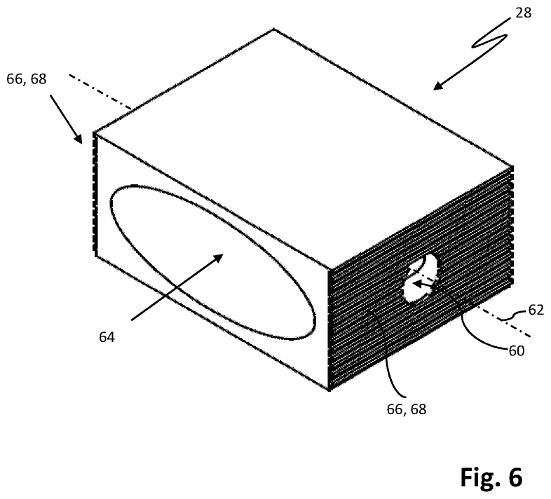

FIG. 6 is a perspective view that has been free-form selected of the adjustment element 28. The adjustment element 28 comprises first latching means 68 in the form of corrugations on its two end faces 66 that face away from one another. In this case, the corrugations extend over the entire width b (cf. FIG. 4) of the adjustment element 28. The first latching means 68 interacts with second latching means 70 on the insides 72 (FIG. 5) of the two side walls 54 of the head segment 26 such that the adjustment element 28 can move in the direction of the longitudinal axis 52 of the head segment 26, relative to the two side walls 54, into different latching positions when the adjustment fitting 10 is not mounted. As a result, the functional height 74 of the adjustment fitting 10, which corresponds to the particular spacing between the bore 60 and the through-opening 40 in the foot segment 24 of the adjustment fitting 10, can be adapted in order to fasten the carrier rail 18 to the post profile 16.

When the head portion 26 is mounted on the carrier rail 18, the adjustment element 28 can be clamped between the two side walls 54 of the head segment 26, transversely to the longitudinal axis of the head segment 26, i.e. in the direction of the body axis 62 of the adjustment element 28, by means of the fastening means 42 that is formed as a bolt and an associated nut 44. As a result, the adjustment element 28, which is in latching engagement with the side walls 54 at both ends, can be immovably clamped between the two side walls, i.e. locked on the head segment 26 in its particular latching position such that it cannot move in the direction of the longitudinal axis 52 of the head segment 26.

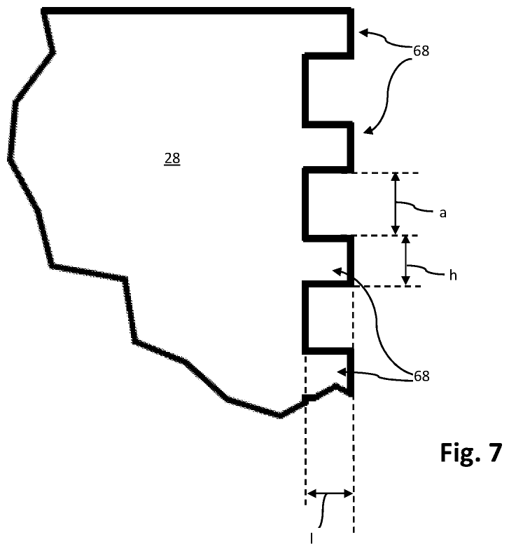

FIG. 7 is a longitudinal section of a cut-out of the adjustment element 28. The first latching means 68 of one end face 66 of the adjustment element 28 are clearly visible. The individual corrugations can each have a uniform corrugation height h and a uniform corrugation length l. The corrugation height h and the corrugation length l can in particular be 1 mm. The corrugations are preferably evenly spaced apart. The corrugation spacing a is selected to be larger than the corrugation height h in this case in order to prevent the adjustment element 28 getting clamped between the side walls 54 of the head segment 26 (FIG. 5). The first latching means 68 of the adjustment element 28 and the second latching means 70 of the side walls 54 preferably have a matching geometric structure and matching dimensions.

The above-mentioned adjustment fitting 22 is inexpensive to produce and allows carrier rails 18 for solar panels 12 to be mounted to anchored post profiles in an overall simpler manner.

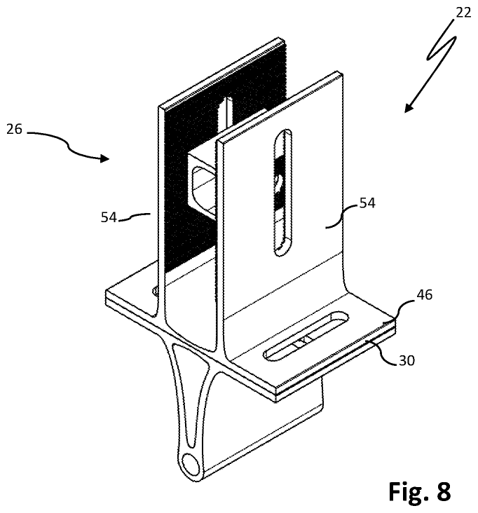

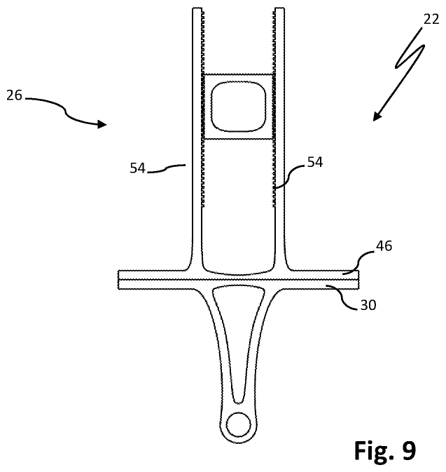

FIGS. 8 and 9 show an alternative embodiment of an adjustment fitting 22. The embodiment of the adjustment fitting 22 substantially corresponds to the embodiment of the adjustment fitting 22 according to FIGS. 3 to 5. Side walls 54 of a head segment 26 are, however, only connected to the bottom of the head segment 26 by means of a second mounting flange 46, and not by means of an end wall on the upper side (cf. FIG. 5: end wall 56).

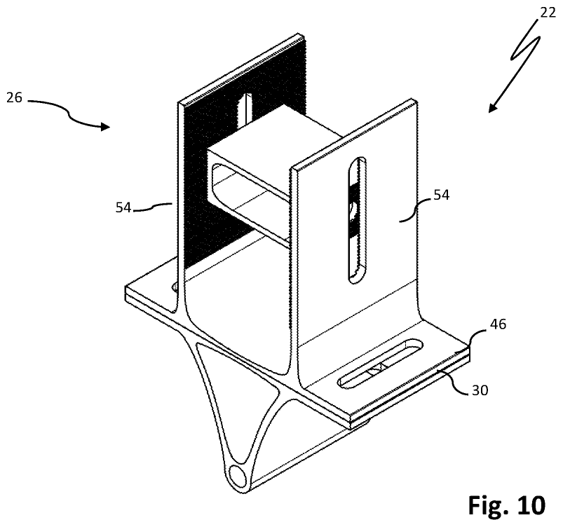

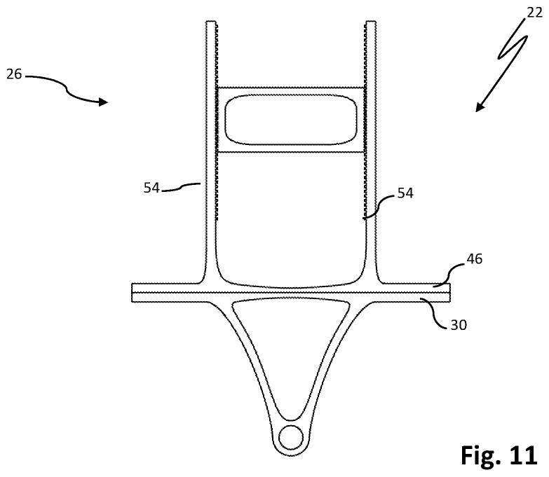

FIGS. 10 and 11 show another alternative embodiment of an adjustment fitting 22, the embodiment of which substantially corresponds to the embodiment of the adjustment fitting 22 according to FIGS. 8 and 9. However, the side walls 54 of a head segment 26 are at a greater spacing from one another than in the head segment 26 according to FIGS. 8 and 9.

Both the adjustment fitting 22 according to FIGS. 8 and 9 and the adjustment fitting 22 according to FIGS. 10 and 11 comprise tapered mounting flanges 30, 46 in the region between the side walls 54 such that the adjustment fitting 22 is particularly lightweight, but nevertheless stable.

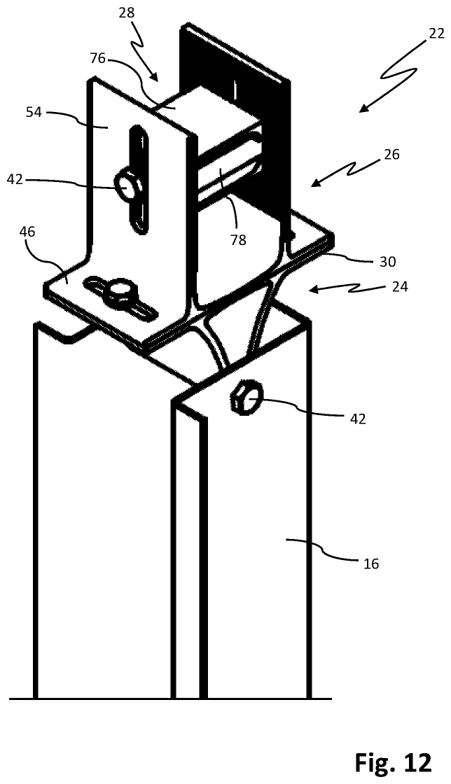

FIG. 12 shows a fourth embodiment of an adjustment fitting 22 that is mounted on a post profile 16. The adjustment fitting 22 corresponds to the adjustment fitting 22 according to FIGS. 10 and 11 with respect to its foot segment 24 and its head segment 26. However, in this case the adjustment fitting 22 comprises a two-part adjustment element 28. The adjustment element 28 comprises a main part 76 and a closure element 78. The closure element 78 is inserted into the main part 76. A fastening means 42, in this case a screw, projects through the side walls 54 of the head segment 26 and the adjustment element 28.

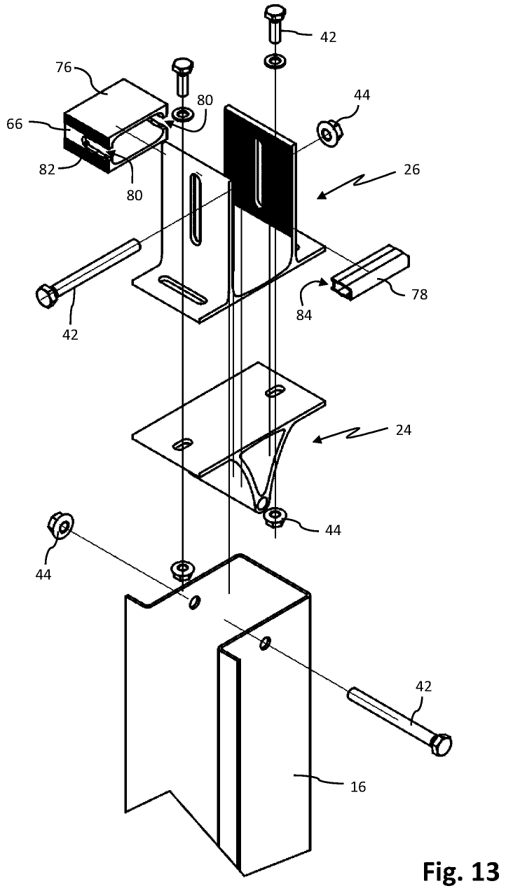

FIG. 13 is an exploded view of the adjustment fitting according to FIG. 12. The main part 76 of the adjustment element is in the form of a hollow extruded profile in this case. Slots 80 are made in both end faces 66 of the main part 76, which slots are open on one side. Each of the slots 80 comprise a closed end 82, in this case approximately in the center of the end faces 66. The closure element 78 comprises a front part 84, which is concave in this case. In the mounted state (cf. FIG. 12), the closure element 76 is inserted into the slots 80 in the main part 76. In this case, the front part 84 of the closure element 78 faces the closed end 82 of the slots 80. Together, the closed end 82 of the slots 80 in the main part 76 and the front part 84 of the closure element 78 delimit a bore (cf. FIGS. 4 and 6, reference sign 60 in each figure) through which the fastening means 42 passes. A first circumferential portion of the bore 60 is delimited by the closed end 82 of the slots 80 in this case. A second circumferential portion of the bore 60 is delimited by the front part 84 of the closure element 78.

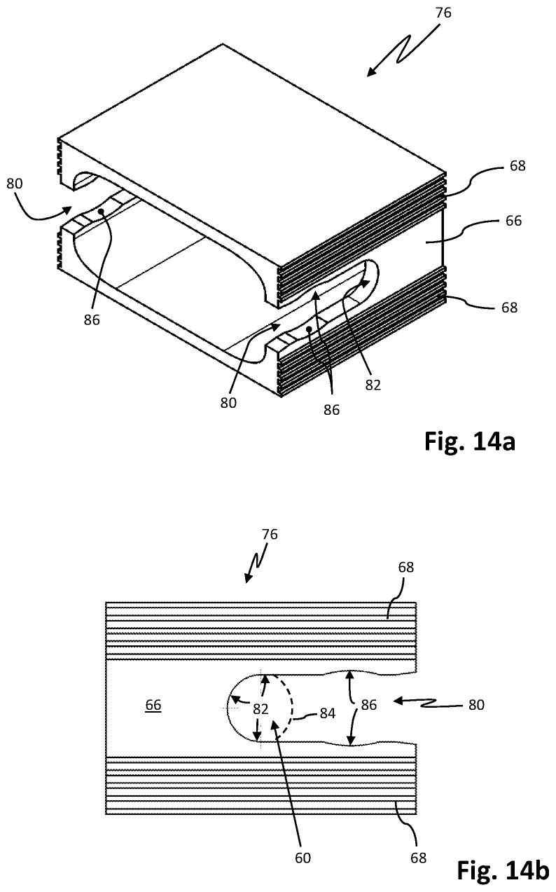

FIGS. 14a and 14b are an enlarged perspective view and a side view, respectively, of the main part 76. It can be seen that each of the slots 82 comprise indentations 86.

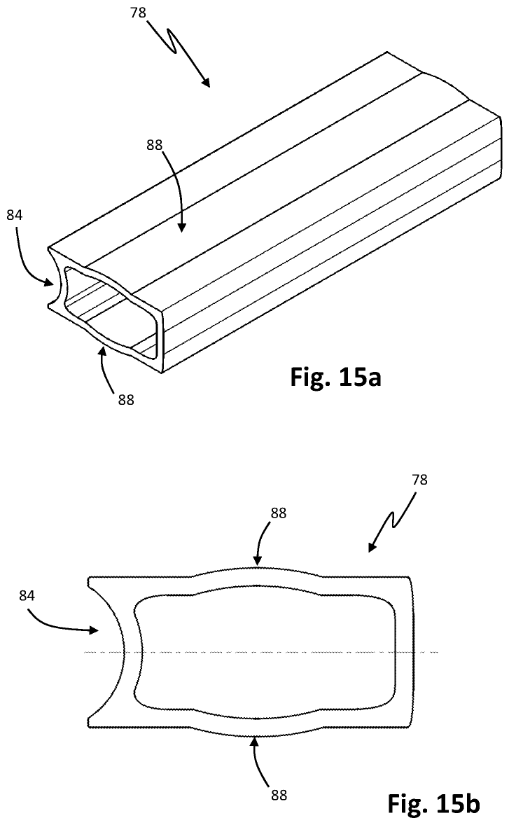

FIGS. 15a and 15b are an enlarged perspective view and a side view, respectively, of the closure element 78. The closure element 78 comprises bulges 88 on the upper and lower side in each case. In the mounted state of the adjustment element 22 (cf. FIG. 12), the bulges 88 of the closure element 78 engage in the indentations 86 in the slots 80 in the main part 76. The closure element 78 is latched to the main part 76 in this manner.

The front part 84 of the closure element 78 is concave in this case. When the closure element 78 is inserted into the main part 76, the bore 60 for receiving the fastening means 42 is delimited by the closed ends 82 of the slots 80 together with the front part 84. The front part 84 of the closure element 78 is indicated by a dashed line in FIG. 14b.

What is claimed is:

1. An adjustment fitting for fastening a solar panel carrier rail to a post profile that is anchored to the ground, comprising:
a foot segment, comprising a first mounting flange and comprising a fastening portion, which extends away from the mounting flange on one side of the first mounting flange and is used to fasten the foot segment to the post profile;
a head segment, comprising a second mounting flange for bearing the head segment and fastening it to the first mounting flange of the foot segment, which can be inserted into the carrier rail portion by portion and comprises an elongate hole in two side walls that are arranged opposite one another;
an adjustment element, which is arranged between the two side walls of the head segment, wherein the adjustment element is provided with first latching means on its two end faces, which means interacts with second latching means on the insides of the two side walls of the head segment such that the adjustment element can move in the direction of the longitudinal axis of the head segment, relative to the two side walls, into different latching positions when the adjustment fitting is not mounted, and wherein the adjustment element is provided with a bore, which is aligned with the elongate holes in the head segment, for a fastening means that is used to fasten the head segment to the carrier rail and to lock the adjustment element in its particular latching position on the head segment by means of the compression of the side walls, such that it cannot move.

2. The adjustment fitting according to claim 1, wherein the first latching means and/or the second latching means each comprise corrugations that extend over an entire width (b) of the adjustment element.

3. The adjustment fitting according to claim 2, wherein the corrugations have a rectangular or a square cross section.

4. The adjustment fitting according to claim 1, wherein, in order to connect the head segment to the foot segment, the first mounting flange and the second mounting flange each comprise fastening recesses for fastening means.

5. The adjustment fitting according to claim 4, wherein the fastening recesses in the first mounting flange and/or the fastening recesses in the second mounting flange are each formed as an elongate hole.

6. The adjustment fitting according to claim 1, wherein the fastening portion of the foot segment extends away from the first mounting flange on one side of the first mounting flange.

7. The adjustment fitting according to claim 6, wherein the fastening portion comprises a through-opening in its free end region for a fastening means, which opening extends over an entire width (B) of the first mounting flange.

8. The adjustment fitting according to claim 6, wherein the fastening portion comprises two legs, which are arranged on the first mounting flange and merge, thereby forming the free end region of the fastening portion.

9. The adjustment fitting according to claim 1, wherein the two side walls of the head segment are connected to one another by means of an end wall that is spaced apart from the second mounting flange.

10. The adjustment fitting according to claim 1, wherein the head segment is formed as one piece.

11. The adjustment fitting according to claim 1, wherein the adjustment fitting as a whole is made of metal, being steel or aluminum.

12. The adjustment fitting according to claim 1, wherein the adjustment element comprises a main part and a closure element, each of which delimit part of the circumference of the bore.

13. The adjustment fitting according to claim 12, wherein the main part of the adjustment element comprises a slot in each of its two end faces, which slot is open on one side.

14. The adjustment fitting according to claim 12, wherein the closure element can be inserted into the main part and can be latched inside the main part.

15. A carrier system for one or more solar panels, comprising:
a plurality of post profiles, which are anchored to the ground at a spacing from one another; and
at least one carrier rail, which is fastened to at least two of the post profiles (16) by means of an adjustment fitting according to claim 1 in each case.
